(19) United States
(12) Patent Application Publication
(10) Pub. No.: US 2006/0221274 A1
(43) Pub. Date: Oct. 5, 2006

(54) Liquid crystal display with compact configuration

(75) Inventors: Song Lv, Shenzhen (CN); Ching-Huang Lin, Miao-Li (TW); Chih-Hung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/397,582

(22) Filed: Apr. 3, 2006

(30) Foreign Application Priority Data
Apr. 1, 2005 (TW) 94205119

(51) Int. Cl. G02F 1/1335

(52) U.S. Cl. 349/70; 349/69

(57) ABSTRACT

A liquid crystal display (100) has a first panel (14); a second panel (12) opposite to the first panel; a liquid crystal layer sandwiched between the two panels; and at least one light source (20) for providing light beams. The first panel directly introduces the light beams from the light source into the LCD for displaying images.

### BACKGROUND

1. Field of the Invention

The present invention relates to liquid crystal displays (LCDs), and particularly to LCDs having a compact configuration.

2. General Background

In general, LCDs have two main advantages in comparison with cathode ray tubes (CRTs): LCDs are thin, and have low power consumption. It has been said that LCDs might one day completely replace CRT display devices, and LCDs have aroused great interest in many industries in recent times. In general, an LCD needs a surface light source to provide even light for a clear display.

A typical liquid crystal display (LCD) 300 is shown in FIG. 11. The LCD 300 has a flexible printed circuit board (FPCB) 310, a liquid crystal panel 320, a frame 330, two light sources 340, and a light guide plate 400. The frame 330 accommodates the liquid crystal panel 320, and the light sources 340 and the light guide plate 400 under the liquid crystal panel 320. The FPCB 310 electrically connects with the liquid crystal panel 320.

The FPCB 310 includes a main circuit area 311, and a smaller light source area 312 extending from the main circuit area 311. The light sources 340 are provided on the light source area 312 of the FPCB 310. The frame 330 has a depressed portion 331 at one end thereof, the depressed portion 331 extending inwardly from one sidewall (not labeled) of the frame 330. Two notches 332 are formed in the depressed portion 331, for accommodating the light sources 340.

A method of assembling the LCD 300 includes the following steps: putting the light guide plate 400 in the frame 330; putting the light source area 312 of the FPCB 310 in the depressed portion 331 of the frame 330, and putting the light sources 340 in the notches 332 of the frame 330; folding an inner end of the light source area 312 of the FPCB 310, so that the frame 330 is folded onto the main circuit area 311 of the FPCB 310 and the main circuit area 311 is located under the light guide plate 400; and finally, folding the LCD panel 320 onto the light guide plate 400, so that the light guide plate 400 can provide uniform illumination to the LCD panel 320. However, the LCD device 300 has a relatively complex structure, which requires complex manufacturing and assembly processes and results in unduly high costs.

What is needed, therefore, is a more compact LCD.

### SUMMARY

A preferred embodiment of a liquid crystal display (LCD) includes a first panel, a second panel opposite to the first panel, a liquid crystal layer sandwiched between the two panels, and at least one light source for providing light beams. The first panel directly introduces the light beams from the light source into the LCD for displaying images.

Another preferred embodiment of a liquid crystal display (LCD) includes two panels opposite to each other, a liquid crystal layer sandwiched between the two panels, and at least one light source for providing light beams. One of the panels directly introduces light beams from the light source into the LCD for displaying images.

Still another preferred embodiment of a liquid crystal display (LCD) includes an upper panel, a lower panel opposite to the upper panel, a liquid crystal layer sandwiched between the two panels, and at least one light source for providing light beams. The lower panel directly introduces the light beams from the light source into the LCD for displaying images.

Other advantages and novel features will become more apparent from the following detailed description when taken in conjunction with the accompanying drawings.

### BRIEF DESCRIPTION OF THE DRAWINGS

FIG. 1 is an isometric view of an LCD device according to a first embodiment of the present invention.

FIG. 2 is a cross-sectional view taken along line II-II of FIG. 1.

FIG. 3 is schematic, cross-sectional view of a lower panel of the LCD device shown in FIG. 2, showing a plurality of scattering dots formed thereon.

FIG. 4 is a side cross-sectional view of an LCD device according to a second embodiment of the present invention.

FIG. 5 is an exploded, isometric view of an LCD device according to a third embodiment of the present invention.

FIG. 6 is a side cross-sectional view of part of an LCD device according to a fourth embodiment of the present invention.

FIG. 7 is a side cross-sectional view of part of an LCD device according to a fifth embodiment of the present invention.

FIG. 8 is an isometric view of an LCD device according to a sixth embodiment -of the present invention.

FIG. 9 is an isometric view of an LCD device according to a seventh embodiment of the present invention.

FIG. 10 is an exploded, isometric view of an LCD device according to an eighth embodiment of the present invention.

FIG. 11 is a top plan view of a conventional LCD device prior to assembly.

### DETAILED DESCRIPTION OF PREFERRED EMBODIMENT

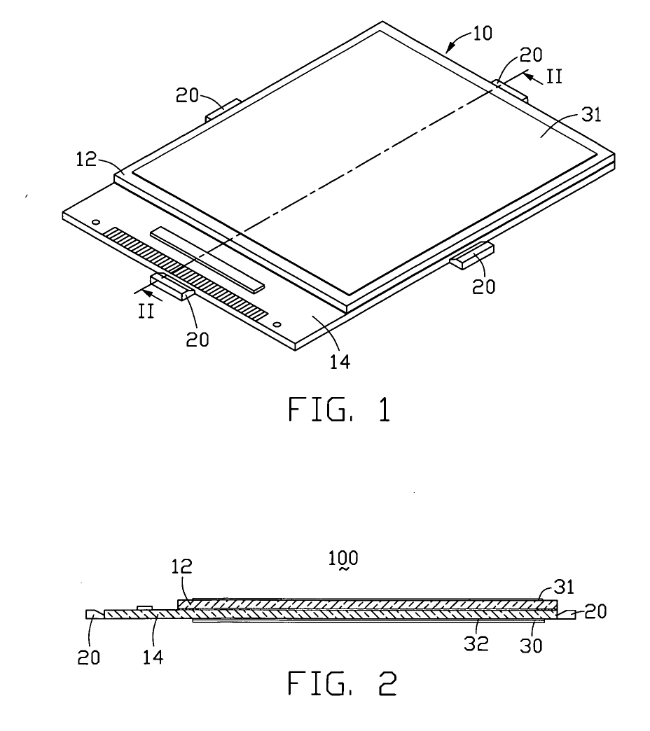

Referring to FIGS. 1-2, an LCD device 100 of a first embodiment of the present invention includes an LCD panel 10 and four light sources 20. The four light sources 20 are set opposite to four sides (not labeled) of the LCD panel 10 respectively, and provide light beams to the LCD panel 10 for displaying images. The LCD panel 10 includes an upper panel 12, a lower panel 14, a liquid crystal layer (not shown) having a plurality of liquid crystal molecules, an upper polarizer 31, a lower polarizer 32, and a reflector 30. The lower panel 14 has a larger area than the upper panel 12. Thus the lower panel 14 provides an exposed edge area for mounting of an IC chip (not labeled) and an FPCB (not shown) thereon.

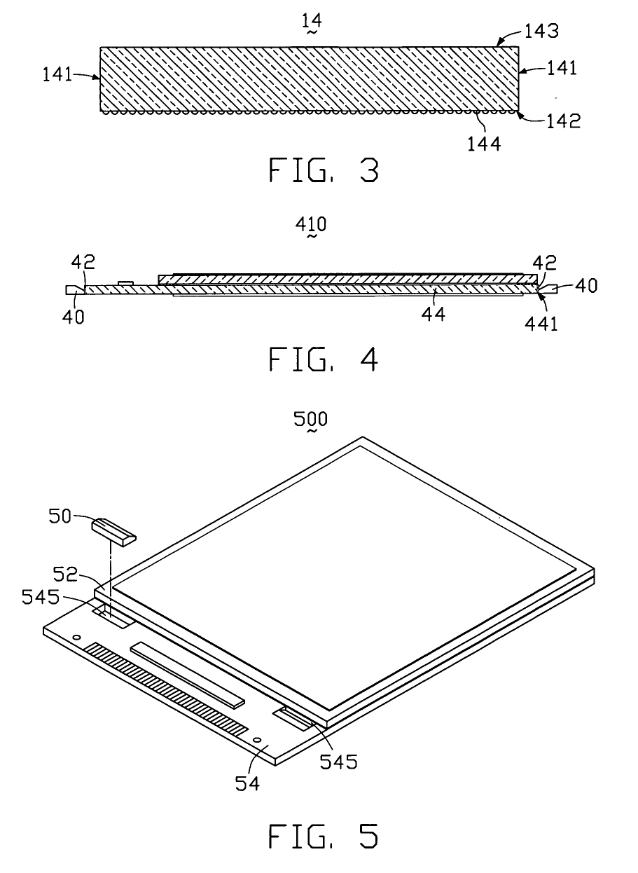

FIG. 3 shows a cross-sectional view of the lower panel 14. The lower panel 14 has four incident surfaces 141 for introducing light beams from the four light sources 20 thereinto respectively, a bottom surface 142 for scattering light beams transmitted inside the lower panel 14 thereto, and a light emitting surface 143 opposite to the bottom surface 142. The incident surfaces 141 are between the bottom surface 142 and the light emitting surface 143. The bottom surface 142 has a plurality of scattering dots 144 formed thereon. The scattering dots 144 thoroughly scatter and reflect light beams incident thereto, thereby providing the whole light emitting surface 143 with even luminance.

In assembly, the upper panel 12 and the lower panel 14 are attached together such that the liquid crystal layer is sandwiched therebetween. The upper polarizer 31 is formed on a top surface (not labeled) of the upper panel 12, and the lower polarizer 32 is adhered on the bottom surface 142 of the lower panel 14. The reflector 30 is provided under the lower polarizer 32, for reflecting light beams back into the lower panel 14.

In operation, when light beams from the four light sources 20 are introduced into the lower panel 14 through the four incident surfaces 141, a portion of the light beams impinging on the bottom surface 142 are totally internally reflected and scattered by the scattering dots 144. The reflected and scattered light beams propagate generally upwardly in the lower panel 14 toward the emitting surface 143, and subsequently are uniformly output from the upper panel 12 of the LCD panel 10. Another portion of the light beams impinging on the bottom surface 142 propagate through the bottom surface 142 and are reflected by the reflector 30 back upwardly toward the emitting surface 143. The reflected light beams are subsequently uniformly output from the upper panel 12 of the LCD panel 10.

Each light source 20 can be a light emitting diode (LED) or a cold cathode fluorescence lamp (CCFL). In alternative embodiments, the lower polarizer 32 can be a reflective polarizer, in which case the reflector 30 can be omitted. Each incident surface 141 can have an antireflective film formed thereon, to prevent light beams from leaking out from the lower panel 14 thereat.

Referring to FIG. 4, an LCD device 410 in accordance with a second embodiment of the present invention has a structure similar to that of the LCD device 100 of the first embodiment. The LCD device 400 has four lower polarizers 42 set on four incident surfaces 441 of a lower panel 44, respectively. Each lower polarizer 42 is between the corresponding incident surface 441 and a corresponding light source 40.

Referring to FIG. 5, an LCD device 500 in accordance with a third embodiment of the present invention has a structure similar to that of the LCD device 100 of the first embodiment. However, two notches 545 are defined in an exposed end of a lower panel 54 that is not covered by an upper panel 52. The two notches 545 are generally adjacent and parallel to one side (not labeled) of the upper panel 52. Two light sources 50 are received in the notches 545.

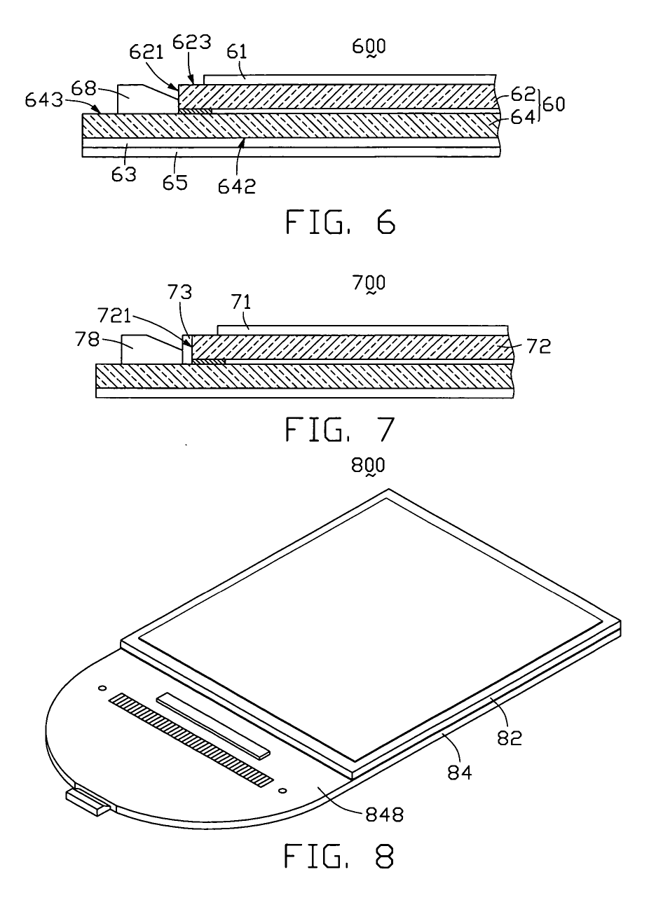

Referring to FIG. 6, part of an LCD device 600 in accordance with a fourth embodiment of the present invention is shown. The LCD device 600 includes an LCD panel 60 and a light source 68. The LCD panel 60 includes an upper panel 62, a lower panel 64, a liquid crystal layer between the upper and lower panels 62, 64, an upper polarizer 61, a lower polarizer 63, and a reflector 65.

The lower panel 64 has a bottom surface 642, and a light emitting surface 643 opposite to the bottom surface 642. The bottom surface 642 has a plurality of scattering dots (not shown) formed thereon. The scattering dots thoroughly scatter and reflect light beams incident thereto, thereby providing the whole light emitting surface 643 with even luminance.

The upper panel 62 has an incident surface 621 for introducing of light beams from the light source 68 thereinto, and a top surface 623 perpendicular to the incident surface 621 and being distal from the liquid crystal layer. The top surface 623 has a plurality of V-shaped or rectangular-shaped grooves (not shown) formed thereon.

In assembly, the upper panel 62 and the lower panel 64 are attached together such that the liquid crystal layer is sandwiched therebetween. The light source 68 is disposed on an exposed end of the emitting surface 643 of the lower panel 64 that is not covered by the upper panel 64, in a position adjacent to the incident surface 621 of the upper panel 62. The upper polarizer 61 is formed on the top surface 623 of the upper panel 62, and the lower polarizer 63 is adhered on the bottom surface 642 of the lower panel 64. The reflector 65 is provided under the lower polarizer 63, for reflecting light beams back into the lower panel 64.

In operation, when light beams from the light source 68 are introduced into the upper panel 62 through the incident surface 621, a large proportion of light beams impinging on the top surface 623 of the upper panel 62 are reflected at the grooves and propagate back down through the upper panel 62. The light beams propagate through the liquid crystal layer, the lower panel 64 and the lower polarizer 63, and then are reflected by the reflector 65 back upwardly. The light beams then propagate through the lower polarizer 63, the lower panel 64, the liquid crystal layer, the upper panel 62 and the upper polarizer 61 in sequence, and are output from the upper polarizer 61.

Referring to FIG. 7, part of an LCD device 700 in accordance with a fifth embodiment of the present invention is shown. The LCD device 700 has a structure similar to that of the LCD device 600 of the fourth embodiment. The LCD device 700 has a lower polarizer 73 set on the incident surface 721 of an upper panel 72, the lower polarizer 73 being between the incident surface 721 and a light source 78. The LCD device 700 also has an upper polarizer 71 on top of the upper panel 72.

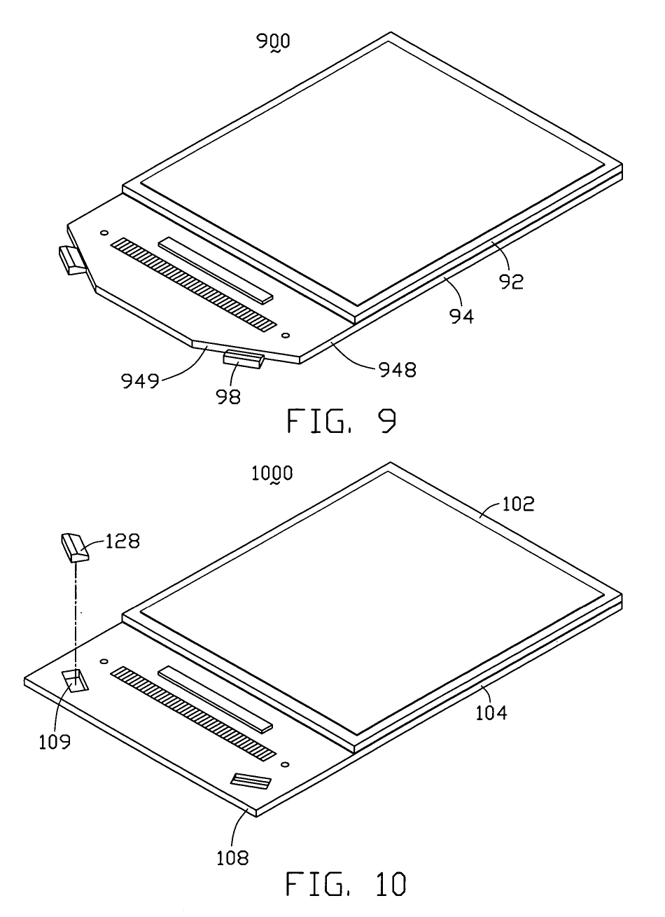

Referring to FIG. 8, an LCD device 800 in accordance with a sixth embodiment of the present invention has a structure similar to that of the LCD device 100 of the first embodiment. However, an exposed end 848 of a lower panel 84 not covered by an upper panel 82 has a generally hemicyclic profile. In alternative embodiments, the exposed end 848 can have a generally curved, semicircular or arch-shaped profile.

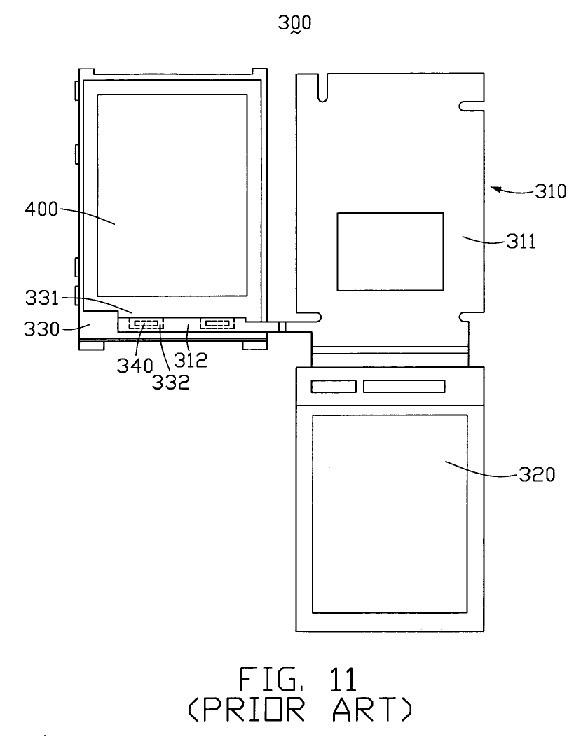

Referring to FIG. 9, an LCD device 900 in accordance with a seventh embodiment of the present invention has a structure similar to that of the LCD device 100 of the first embodiment. However, an exposed end 948 of a lower panel 94 not covered by the upper panel 92 has two oblique corner portions 949 at two distal corners thereof. Two light sources 98 are disposed adjacent to the two corner portions 949 respectively. Light beams from the light sources 98 are introduced into the lower panel 94 through the two corner portions 949.

Referring to FIG. 10, an LCD device 1000 in accordance with an eighth embodiment of the present invention has a structure similar to that of the LCD device 500 of the third embodiment. However, two notches 109 are formed in two corners 108 of an end of a lower panel 104 that is not covered by an upper panel 102. Two light sources 128 are received in the two notches 109, respectively.

In summary, in various embodiments of the LCD device, one or more light sources are disposed adjacent one or more side surfaces of an upper panel or a lower panel, or in a lower panel. The upper panel or the lower panel functions to change a direction of propagation of light beams emitted from the light sources into the upper panel or the lower panel, from a direction roughly parallel to an emission face of the upper panel or the lower panel to a direction generally perpendicular to the emission face. That is, the upper panel or the lower panel effectively changes the linear or point light source(s) into a surface light source, for illuminating a whole display screen (not shown) of the LCD device evenly. The LCD device utilizes the upper panel or the lower panel of an LCD panel in much the same way as a light guide plate used in a conventional LCD device, and therefore need not include a light guide plate. Therefore, the LCD device can have a high space utilization ratio and a compact size. Moreover, because the upper panel or the lower panel has a scattering pattern formed thereon, the LCD device can attain highly uniform illumination.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A liquid crystal display, comprising:
a first panel;
a second panel generally opposite to the first panel;
a liquid crystal layer sandwiched between the two panels; and
at least one light source adjacent to or in the first panel and/or the second panel, for providing light beams to the first panel and/or the second panel.

2. The liquid crystal display as claimed in claim 1, wherein the first panel has a scattering pattern.

3. The liquid crystal display as claimed in claim 2, wherein the scattering pattern is a plurality of scattering dots or a plurality of V-shaped or rectangular-shaped grooves.

4. The liquid crystal display as claimed in claim 1, further comprising a polarizer provided at a top surface of the first panel, and another polarizer provided at a bottom surface of the second panel.

5. The liquid crystal display as claimed in claim 1, further comprising a polarizer provided at a top surface of the first panel, and at least one other polarizer provided between the first panel and the at least one light source.

6. The liquid crystal display as claimed in claim 1, wherein the at least one light source is a light emitting diode (LED) and/or a cold cathode fluorescence lamp (CCFL).

7. The liquid crystal display as claimed in claim 1, wherein a reflector is provided under the second panel for reflecting light beams back into the second panel.

8. The liquid crystal display as claimed in claim 1, wherein the at least one light source is beside at least one sidewall of the first panel.

9. The liquid crystal display as claimed in claim 1, wherein the at least one light source is disposed on the second panel beside at least one sidewall of the first panel.

10. The liquid crystal display as claimed in claim 1, wherein the at least one light source is received in at least one notch defined in one end of the second panel.

11. The liquid crystal display as claimed in claim 10, wherein the at least one light source is two light sources, at least one notch is two notches, and the notches are defined at two corners of the end of the second panel.

12. The liquid crystal display as claimed in claim 10, wherein the at least one notch is defined in the end of the second panel generally adjacent one sidewall of the first panel.

13. The liquid crystal display as claimed in claim 1, wherein the second panel has two corner portions at one end thereof.

14. The liquid crystal display as claimed in claim 12, wherein the at least one light source is two light sources, and the light sources are adjacent the corner portions.

15. A liquid crystal display, comprising:
two panels generally opposite to each other;
a liquid crystal layer sandwiched between the two panels; and
at least one light source adjacent to or in one of the panels, for providing light beams to said one of the panels.

16. The liquid crystal display as claimed in claim 15, wherein the at least one light source is disposed at at least one side of said one of the panels.

17. The liquid crystal display as claimed in claim 15, wherein said light source is aligned with said one of the panels in a plane coplanar with another plane defined by said one of the panels.

18. A liquid crystal display, comprising:
an upper panel;
a lower panel generally opposite to the upper panel;
a liquid crystal layer sandwiched between the two panels; and
at least one light source adjacent to or in the lower panel and/or the upper panel, for providing light beams to the lower panel and/or the upper panel.

19. The liquid crystal display as claimed in claim 18, wherein the at least one light source is disposed at at least one side of the lower panel and/or the upper panel.

20. The liquid crystal display as claimed in claim 18, wherein said light source is aligned with said lower and/or upper panels in a plane coplanar with another plane defined by said lower and/or upper the panels.
